(19) United States
(12) Patent Application Publication
(10) Pub. No.: US 2009/0002367 A1
(43) Pub. Date: Jan. 1, 2009

(54) METHOD AND SYSTEM FOR A COMMUNICATIONS INFORMATION INTERFACE

(76) Inventor: SEAN ALEXIS, Seattle, WA (US)

Correspondence Address: KENYON & KENYON LLP, ONE BROADWAY, NEW YORK, NY, 10004, US

(21) Appl. No.: 12/163,986

(22) Filed: Jun. 27, 2008

Related U.S. Application Data
(60) Provisional application No. 60/937,580, filed on Jun. 27, 2007.

(51) Int. Cl. G06T 15/00

(52) U.S. Cl. 345/419

(57) ABSTRACT

A system and method is provided which allows for user-interactive, multi-dimensional information about coverage areas of wireless service providers. Map data can be continually updated by third party mapping systems, and the coverage data can be continually updated by coverage data repositories maintained by the respective wireless service provider or other entity. Example systems provide users an opportunity to explore coverage areas in a two- or more-dimensional, interactive map including map data and coverage strength layers presented via a user interface.

### BACKGROUND

In wireless communication systems there are areas in which users cannot obtain wireless service altogether. Additionally, there are numerous areas where calls are lost or dropped due to users traveling through a location which provides no or poor wireless access coverage. The increasing abundance of wireless service providers in the marketplace has given customers many options in choosing a wireless service provider. An important factor in customers adopting a wireless service provider has become the reliability and availability of coverage areas.

Many wireless service providers, in an attempt to gain customers and provide an understanding of their wireless access coverage, have provided customers with print-out (e.g., paper) maps of their coverage areas. In addition, many providers also establish Internet databases providing maps and charts of their wireless service access coverage. Quite frequently, customers visit the wireless service provider on-site locations and stores. Here, their main source of information about the wireless access coverage of the service provider is the sales-staff, the printed maps and/or online databases. However, these methods make it difficult to pinpoint exact desired locations in which customers seek wireless access coverage.

Present systems do not appear to provide a communications information interface which would allow a user, e.g., a potential or current customer, to interact with and learn about the wireless service providers access coverage. Example methods and systems of the present invention allow users to evaluate wireless access coverage areas in an informative and user-friendly manner. Additionally, the interactive portion of example systems allows users to determine exact locations in which wireless access service is provided and gain interactive feedback from the user-friendly system.

### SUMMARY OF THE INVENTION

Embodiments of the present invention provide for a system for providing signal strength data including a display screen, a computer processor, the computer processor providing information to the display screen, a user interface, the user interface being generated at least in part from information provided by the computer processor and being displayable on the display screen. The information includes data concerning a wireless signal strength of a network provider in a specific geographic area, the user interface displaying the information in a multi-dimensional view in response to at least one of: a dynamic instruction and a preloaded instruction. In an embodiment, the dynamic instruction is derived from a request inputted via the user interface. In an embodiment, the preloaded instruction is a stored instruction on a memory of the computer processor or an accessible remote memory source. In an embodiment, the computer processor obtains the information from at least one of: Internet, a remote information source, a server, and a computer-readable memory device. In an embodiment, the display screen with (or without) the computer processor are a stand-alone system. In an embodiment, the display of the specific geographic area is a three-dimensional view. In an embodiment, the at least one of the dynamic instruction and the preloaded instruction is a display request for the specific geographic area based on at least one of the following parameters: geographic coordinates, relative signal strength, relative signal weakness, and a commercial location with a certain signal strength.

Embodiments of the present invention provide for a method for displaying a wireless signal strength, including providing an instruction to a computer processor via a user interface on a display, the instruction including a request for information of the wireless signal strength for at least one parameter, receiving the information by the computer processor; and displaying the information via a multi-dimensional graphical geographical view by the computer processor on the display, the multi-dimensional view being at least two-dimensional or greater. In an embodiment, the instruction is provided to the computer processor via the user interface by at least one of a manual input and an automatic input. In an embodiment, the at least one of the manual input and the automatic input is from at least one of: a computer-readable memory source, a remote source, an Internet source, a server, a manual-input device, a soft-key input device on the user interface, and a wireless device via a transport protocol. In an embodiment, the display is a display screen, the display screen being provided as a stand alone-accessible device having access to the computer processor. In an embodiment, the at least one parameter is at least one of: a geographic coordinate, a geographic region, a relative signal strength, a landmark, a business entity, a relative signal weakness, and a residential location. In an embodiment, the at least one of the manual input and the automatic input provides at least one of a dynamic instruction and a pre-loaded instruction.

Embodiments of the present invention provide for a user interface of a communication device, including an input display allowing instructional input of a search parameter, and a multi-dimensional graphical geographical view generated by an associated computer processor being displayed via the user interface of the communication device. The at least one wireless carrier signal strength is shown on the multi-dimensional graphical geographical view. The instructional input is effected via at least one of a soft-key function shown on the input display, a hard-key function via a keyboard device associated with the display, and a source remote to the input display. In an embodiment, the search parameter is at least one of a geographic coordinate, an address, a landmark name, a relative signal strength, a business entity, a relative signal weakness, and a residential location. In an embodiment, the input display provides input fields for a location address. In an embodiment, a location name display is provided allowing input of the search parameter which includes a request to view a specific location, the location name display showing a list of locations, the list of locations being filterable to provide a subset of locations for selection, and in response to a selection of the specific location from the list of locations, the corresponding geographical view is displayed by the user interface. In an embodiment, a map display is provided allowing input of the search parameter which includes a request to explore a map, the map display being navigated using controls, and in response to use of the navigation controls the corresponding geographical view is displayed by the user interface. In an embodiment, the navigation controls are effected via at least one of a soft-key function shown on the map display, a hard-key function via a keyboard device associated with the map display, and a source remote to the map display. In an embodiment, the navigation controls include at least one of a directional control, a tilt control, a zoom-in control, and a zoom-out control.

### BRIEF DESCRIPTION OF THE DRAWINGS

FIG. 1 is a diagram showing the components of an example system according to an example embodiment in the present invention.

FIG. 2 is a diagram showing the components of an example system according to an example embodiment in the present invention.

FIG. 3 shows an example screenshot according to an example embodiment of the present invention.

FIG. 4 is an example screenshot of the present invention showing a graphical display upon activation of a user initiated wireless access coverage check.

FIG. 5 is an example screenshot of the present invention showing a graphical display upon activation of a user initiated wireless access coverage check.

FIG. 6. is an example screenshot of the present invention showing a graphical display upon activation of a user initiated wireless access coverage check.

FIG. 7 is an example screenshot of the present invention showing the graphical display upon completion of a user initiated wireless access coverage check.

FIG. 8 is an example screenshot of the present invention showing the graphical display upon completion of the user initiated wireless access coverage check that will enable the user to observe the wireless access coverage at a specific location using the enter an address feature.

FIG. 9 is an example screenshot of the present invention depicting the graphical display upon completion of the user initiated wireless access coverage check that will enable the user to check the wireless service access coverage at a specific location using the explore the map feature.

FIG. 10 is an example screenshot of the present invention depicting the graphical display upon completion of the user initiated wireless access coverage check that will enable the user to observe the wireless service access coverage at a specific location using the explore the map feature.

FIG. 11 is an example screenshot of the present invention depicting the graphical display upon completion of the user initiated coverage check that will enable the user to check the wireless access coverage at a specific location using the choose a landmark feature.

FIG. 12 is a flowchart illustrating an example method according to an example embodiment of the present invention.

### DETAILED DESCRIPTION

Embodiments of the present invention provide for a system, method, and computer-readable medium for a useable interface to determine wireless signal strength. An embodiment of the present invention provides for a standalone computer terminal. An embodiment of the present invention provides for a kiosk having a computer terminal. A further embodiment of the present invention provides a user to view in three-dimensional space a specific wireless-access signal strength of a network provider.

Embodiments of the present invention may use various system platforms, including those readily available, to display a geographic picture, such as for example, ESRI, MapInfo, and Google Fusion®. Embodiments of the present invention show, in response to a user's request, wireless coverage access.

Embodiments of the present invention provide a user interface which is readily accessible to a user to determine wireless coverage in a specific area. In an embodiment, the specific area is predetermined, and/or is determined by a user. In an embodiment, a specific area may be requested based on a variety of factors including, geographical location, signal strength, and signal weakness. Further, a specific coverage area may be requested or predetermined for display and displayed based on commercial and/or marketing reasons. For example, if a wireless network provider and a retailer wanted to encourage visitors to its locations, a display of the strength of the signal at a specific location of the retailer is shown either upon activation of the system, and/or input by a user for relatively good signal strength locations. Further, a specific coverage area may be requested or predetermined for display, and displayed based on other reasons.

Embodiments of the present invention provide the necessary capabilities to display, dynamically or otherwise, signal strength in a multi-dimensional mapping, e.g., a three-dimensional mapping, unlike any other available solutions. Further, embodiments of the present invention provide for a such capabilities to be accessible via a standalone system. Further embodiments of the present invention provide an easy to use user interface for using and/or viewing such capabilities.

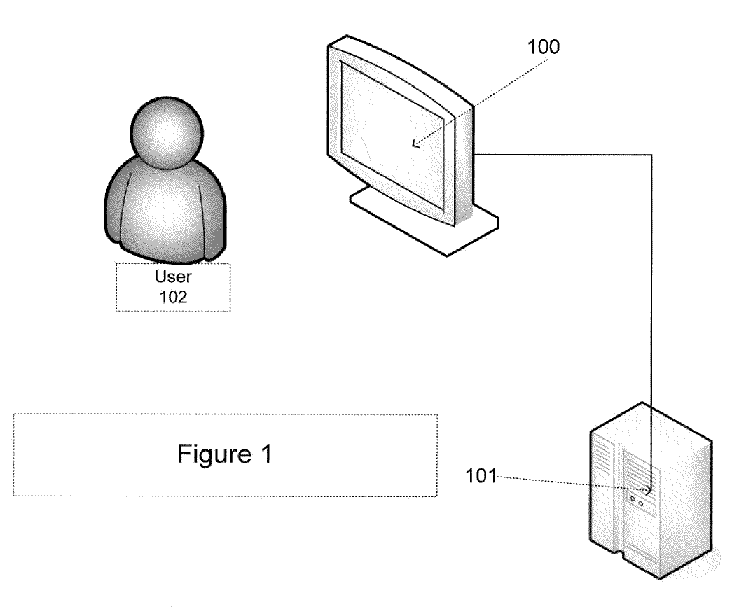

FIG. 1 illustrates an example information terminal, according to an example embodiment of the present invention. The example system includes a workstation 101 that can allow user interaction through a display 100. The example system may be a stand alone terminal or display device, or may be connected to or associate with a larger system. The display 100 can be connected to the workstation 101, either wirelessly or hard-wired or via another available means. Together, these two components are usable to provide an information terminal for wireless service customers. Customers (e.g., user 102) can use an application stored on the system (e.g., workstation 101) and/or accessible by the system, which will allow users to interact with, and learn about, wireless access coverage areas associated with a service provider.

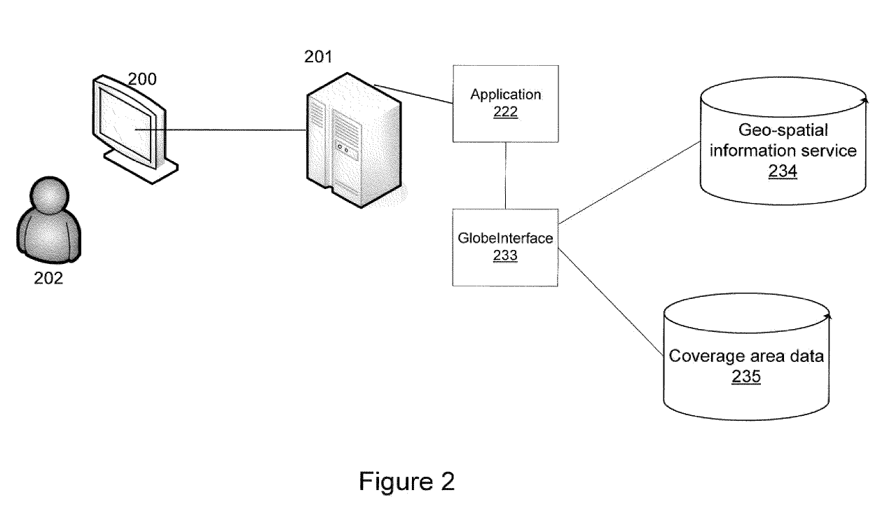

FIG. 2 illustrates another example system, according to an example embodiment of the present invention. In the example system of FIG. 2, an example application 222 provides for user interaction via the display 200 connected to the workstation 201. The application provides interaction through the use of a multi-dimensional, e.g., a 3-dimensional, globe interface 233, which can be integrated with current appropriate geo-spatial information services 234 as well as wireless access coverage mapping layers (e.g., coverage area data 235). The system illustrated by FIG. 2 is only one example, additional platforms for example embodiments of the present invention may also be used. For example, the example application could run on a cell phone, personal computer, personal digital assistant, etc. In an embodiment, those devices can access the relevant information via wireless signals (e.g., cellular service, WiFi, etc.), or hard-wired services (e.g., Ethernet, etc.). Example embodiments of the present invention include large, e.g., such as the system shown in FIG. 2, and small personal systems. The example system illustrated in FIG. 2 may be configured to conform to an already established personal coverage check (PCC) interface, which will be available to the user via the Internet, and can extend that experience through the use of two- or more-dimensional data and a larger interface. Example embodiments of the present invention can be easy for users to use and should be configured as a fun, informative, and interesting experience for evaluate wireless access coverage areas.

In an embodiment, the workstation 201 and the display 200 has a kiosk-like look and feel. In an example embodiment of the present invention, the workstation 201 powering the display 200 runs a known or proprietary operating system, a structured query language (SQL) server, a multi-dimensional (e.g., 2D, 3D) globe application, and has access to web services for base mapping data. In a further embodiment, the workstation has access to mapping layers, which also may reside on the workstation 201 or be connected wirelessly/hardwired/remote storage source to the workstation 201. In an embodiment, the workstation 201 has a network connection (e.g., the Internet) in order to take advantage of web services and/or access remote data repositories. The example system of FIG. 2 can take advantage of certain web services for geo-spatial information, as well as other geo-processing routines that will enhance the user experience. Example web services can include ESRI and/or ArcWeb. Further embodiments provide for the interface application to consist of controls, functions and a globe interface, e.g., ArcGlobe and/or ArcGIS Explorer. Arc products are produced by ESRI and serve as a rich set of Web services application programming interfaces (APIs) for integrating mapping functionality and geographic information services (GIS) content into a browser, desktop, mobile platform, and/or server applications. These products and interfaces are known in the art, and can be used in conjunction with the present application. For example, the example application could include an ArcGIS type explorer interface to guide the user through the overall experience. In a further embodiment, the example application provides web-services for base-mapping data, EMA data layers, and/or a globe visual control.

Example embodiments of the present invention will include an idle state display (e.g., on display 201) configured to encourage user interaction. The example idle state display will demonstrate how the example system works, how to get started using the example system, and/or an example coverage map (e.g., for the area in which the example system is located). For example, the application begins by providing a start location (e.g., a zoomed-out view of the whole globe, the country the example system is located in, the area the example system is located in, etc.) and allows the user to select a destination location. The example embodiment provides a fluid zoom to that location. In a further embodiment, the user can enter a second location, which will cause the example application to “fly” to that new location with a similarly fluid zoom out/in, etc. In a further embodiment, the example application also includes pre-configured “flights” and/or user defined “flights.” An example of a pre-configured “flight” is from a store (e.g., where the example system is located) to a landmark. An example of a user defined flight is from an address to another address (e.g., the current location to the home address of the user). In an embodiment, the example system provides an in-flight coverage experience which includes animated flights in three-dimensional space and/or shows a two-dimensional flight overview. In an embodiment, once the example system has presented a selected area, the example system provides a number of functions. For example, the system describes the service provider's coverage at the destination point, allows for the user to pan, zoom, tilt, etc., allows the user to enter a new coverage area, and/or allows the user to start over (e.g., return to the starting area). In an embodiment, the example system has a built in timeout period (e.g., pre-configured time of inactivity) that triggers the idle state. In a further embodiment, the system also has one or more warnings/prompts to determine if the example system is still in use or should return to the idle state. In an embodiment, the example system captures and records data from the user session and/or experience. In an embodiment, the system has administrative functions and/or provides reports about user activity on the example system. Example systems use a database (e.g., SQL server) to facilitate the logging and reporting of user activities on the system. The same or additional database can store multimedia segments, which could be used as part of the example application.

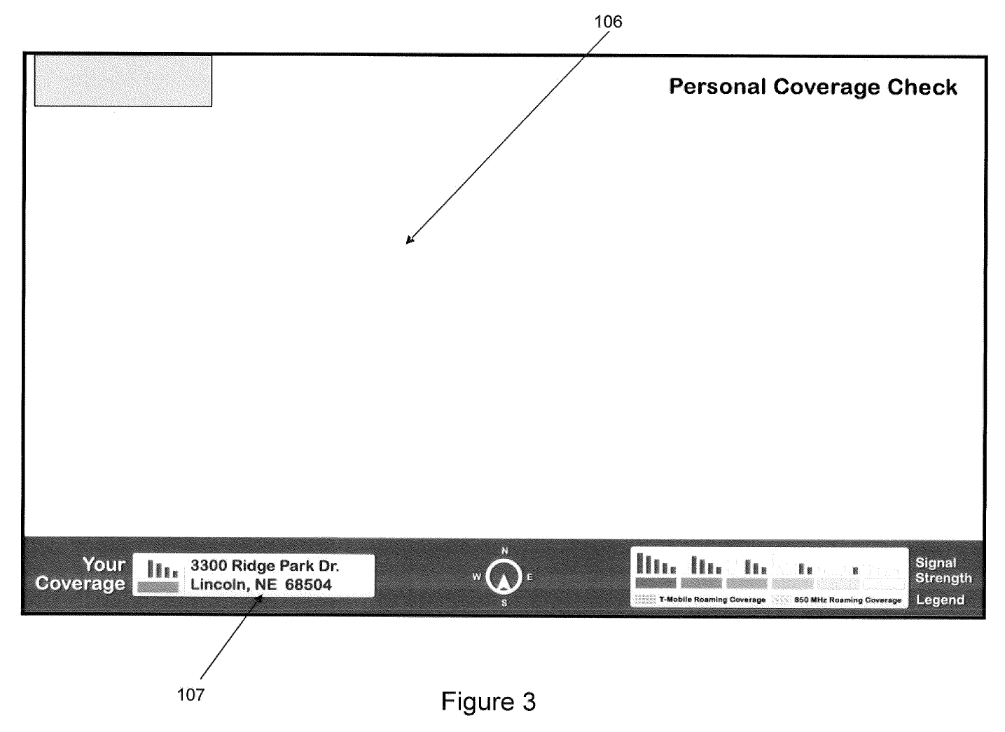

In example embodiments, the application includes audio and/or video clips/segments that support the context where the user is in the application. Further embodiments include a connection between the user interface, the triggers to invoking multimedia, and/or the overall information about the service provider coverage area. The multimedia segments can be used in conjunction with one or more user interfaces. FIG. 3 illustrates an example embodiment of one user interface. The user interface area 106 is where map and coverage data is graphically displayed to the user. In a user interface area, there may be on-screen (or soft-key) activation buttons 107 that show relevant information, such as current address and/or current coverage level, or provide for additional input selections. This information can also be displayed graphically in the user interface area 106, e.g., as a map with graphical coverage layers. The display 201 can have a touch screen and provide the user with a graphical keyboard (e.g., QWERTY, etc.) or other input devices (e.g., buttons) or means. Alternatively, the example system includes a physical keyboard for user input or other input devices. Other user interface displays are also possible depending on the specific implementation of the example system.

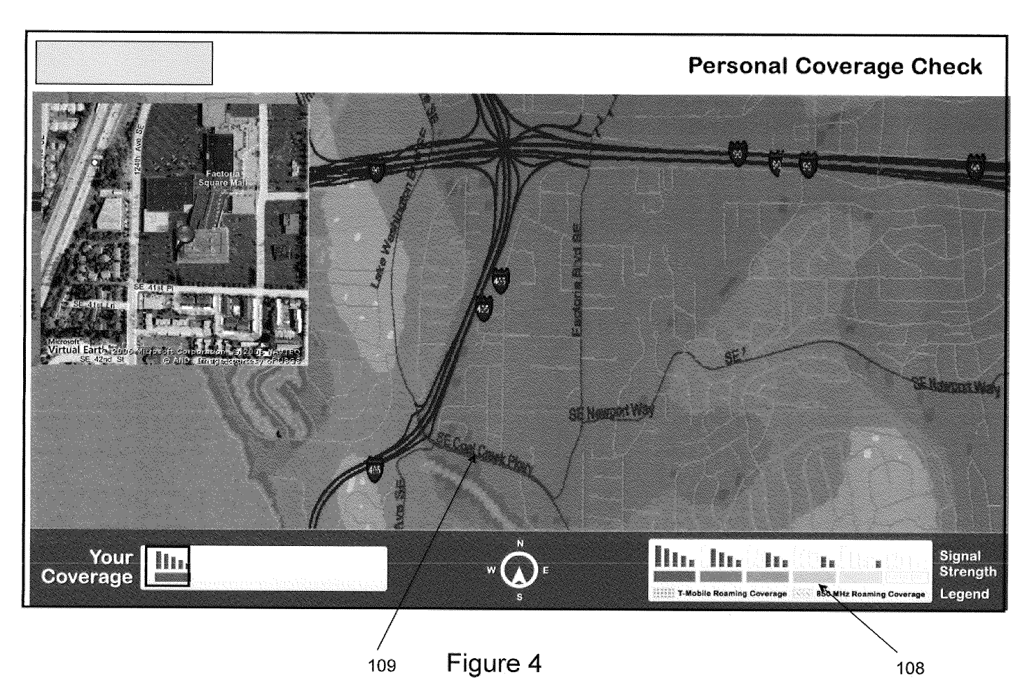

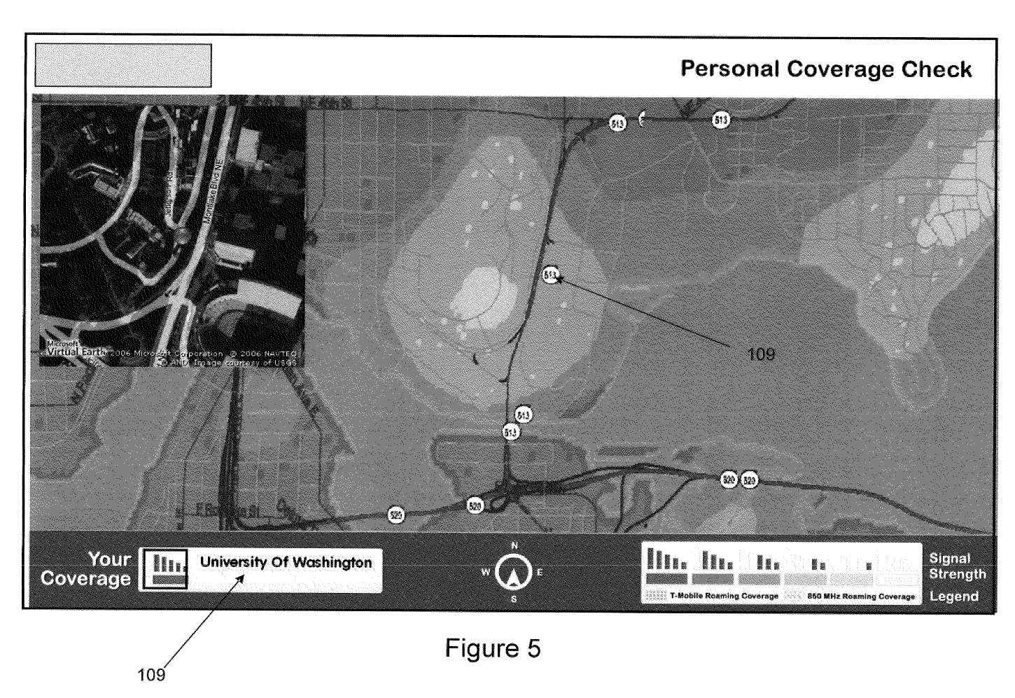

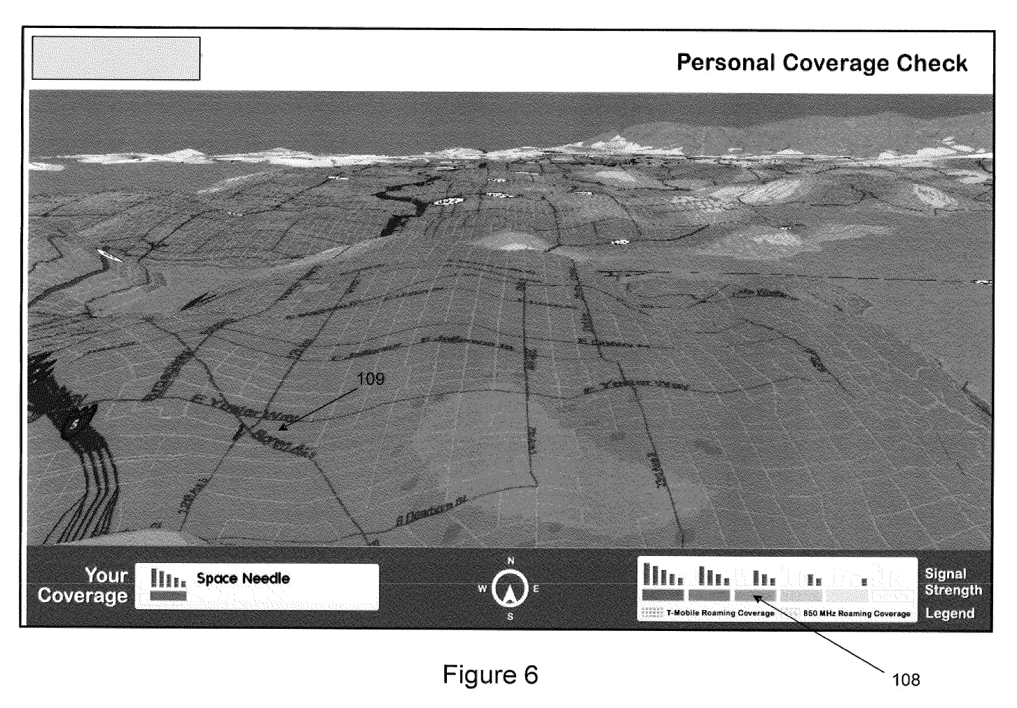

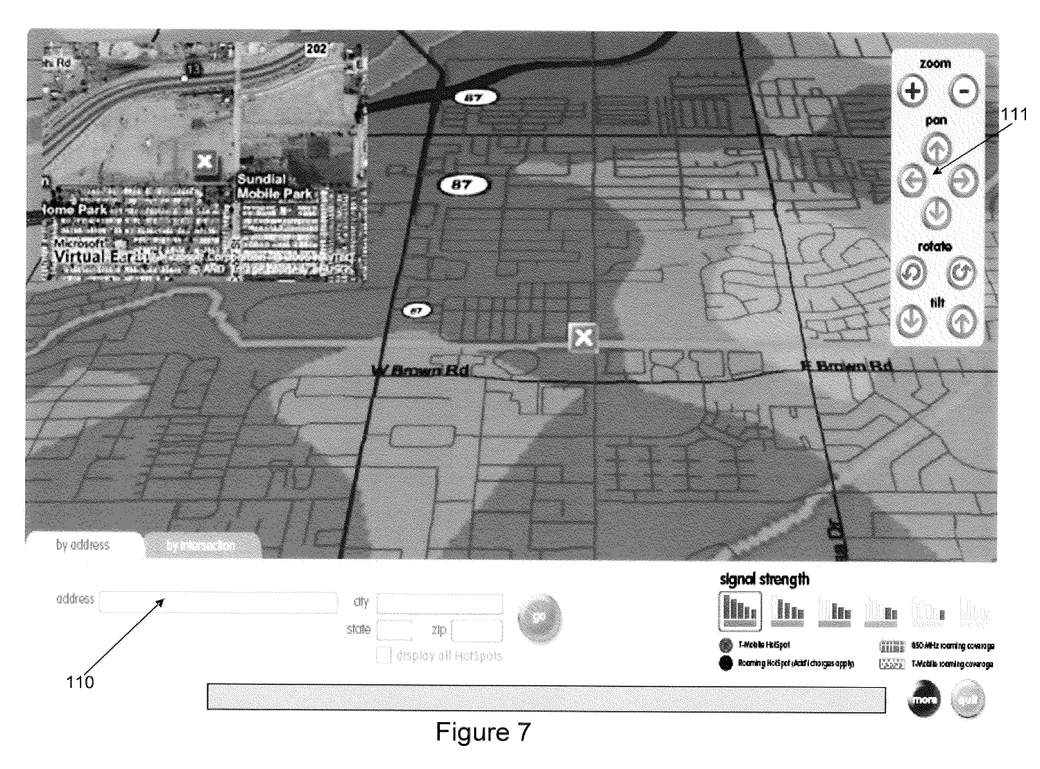

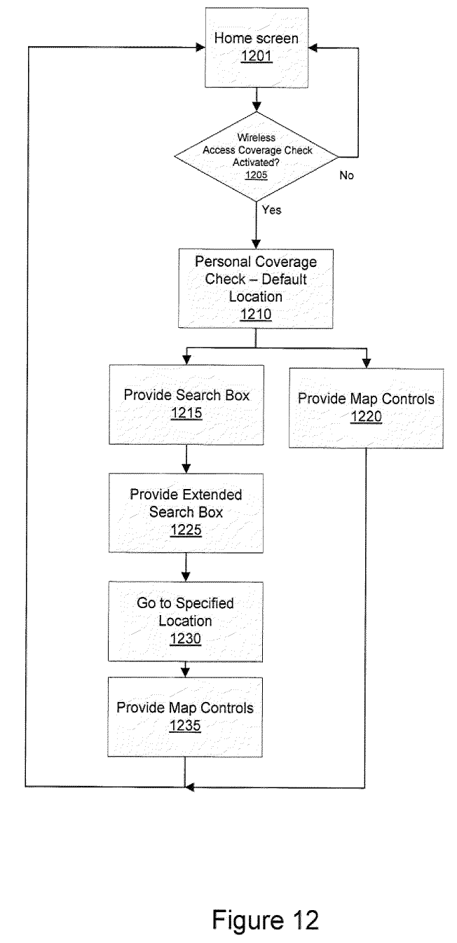

FIG. 12 illustrates an example method of the present invention. The example method begins at a home screen 1201. The home screen 1201 could be the same or similar to the screen shown in FIG. 3. The example method then wait for a user to activate a wireless access coverage check (e.g., at 1205). The home screen (e.g., FIG. 3) also presents the user with a “Check Your Coverage” button 107 inviting the user to begin a personal coverage check process. When the user clicks on the “Check Your Coverage” button 107, the application ‘flies’ to the default location, e.g., the location of the in-store system or any other “default” or specified location. The flight will be a ‘smooth zoom’ to the default location, e.g., not a jump to a view of the map at the default location. Alternatively, the flight could be more of a jump. The personal coverage check 1210, is illustrated by FIG. 4, FIG. 5 and/or FIG. 6. Such map views, for example, display aerial and satellite imagery, e.g., FIGS. 4 and 5, and elevation terrain, e.g., FIG. 6. As illustrated by FIGS. 4, 5, and 6, the maps also render the strength of the wireless access provider's coverage in multiple-dimensions, e.g., two or more dimensions, corresponding to the colored signal strength indicated in the legend 108. Various map labels 109 can also be present in one or more of the displayed maps. The labels can depend on the level of zoom and resolution of the displayed image. These labels can include, for example, cities, roads, highways, parks, airports, landmarks, water bodies, and/or railways. In an embodiment, the flight to a default location ends when the screen shows a preconfigured area (e.g., a 4-mile by 4-mile area) with the default location in the center of the screen, e.g., as illustrated by FIG. 7. In an embodiment, the method provides the user with a set of map controls at 1220 (e.g., as illustrated by 111 of FIG. 7) that the user can use to manually navigate to a location, which shows, for example, the wireless service provider's access coverage area. The controls 1220 (e.g., 111) may enable a number of map functions, including: zooming, tilting, rotating, panning, etc.

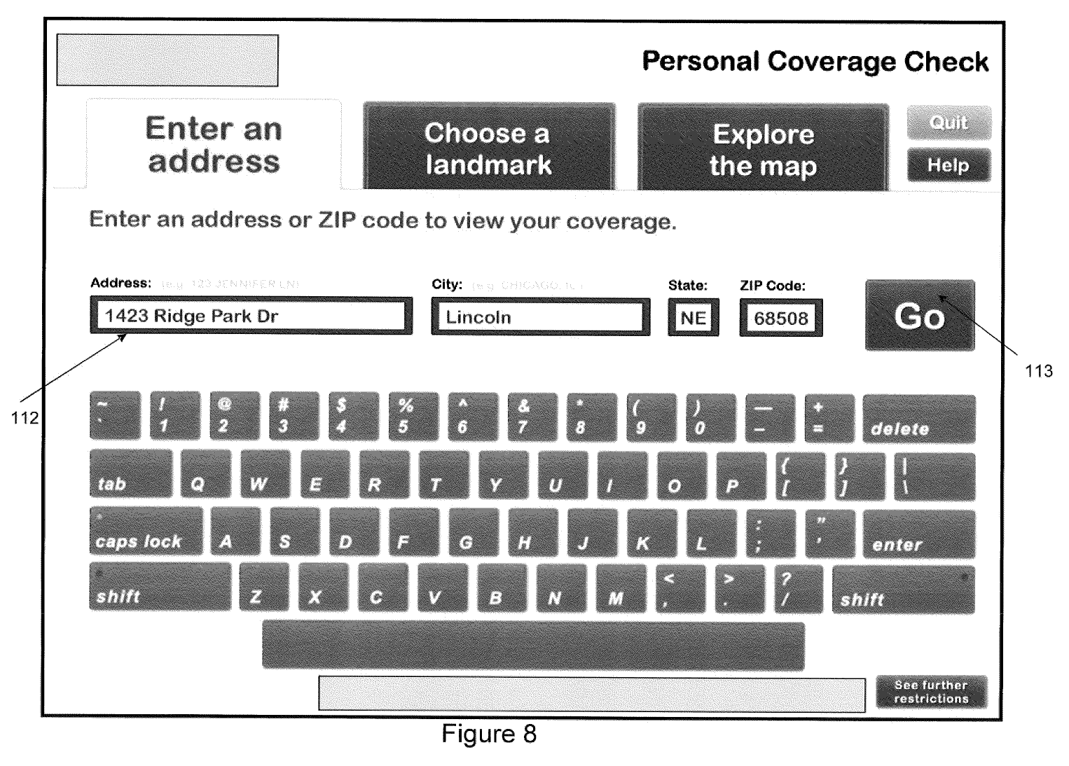

After the example method reaches the default location 1210, the example method then provides the user with an address or intersection search box 1215, (e.g., as illustrated by 110 of FIG. 7) in which the user can input a street address or intersection to check or determine the wireless service provider's access coverage area. This search box may receive input from a standard keyboard (or any other suitable input device), or can bring up an extended search box 1225. The extended search box 1225 is illustrated, for example, by FIG. 8, and includes a touch screen keyboard (or other input device). At 1225, the user specifies a specific location by entering an address/intersection in a search box (e.g., 112 of FIG. 8). There may be a search function (e.g., 113 of FIG. 8) to initiate the actual search. Once the user activates the search function, the user is shown the specified location 1230. The specified location 1230 may include an audio segment that announces the departure location and/or destination location for the “flight” and the total distance between the two locations. In an embodiment, the user is provided other relevant information via audio or other multimedia presentations. In an embodiment, after the audio segment plays, the example method begins a flight from the current location (e.g., the default location) to the destination location the user entered (e.g., in the search box 110, 112). In an embodiment, the example method provides on-screen controls that enable the user to control the speed of the flight to the destination location. In an embodiment, audio and/or video segments that convey wireless access coverage status are played. For example, when the flight reaches its destination, an audio segment announces that the user has arrived at the destination address/intersection. In a further embodiment, the audio describes the coverage the customer would experience at the destination location.

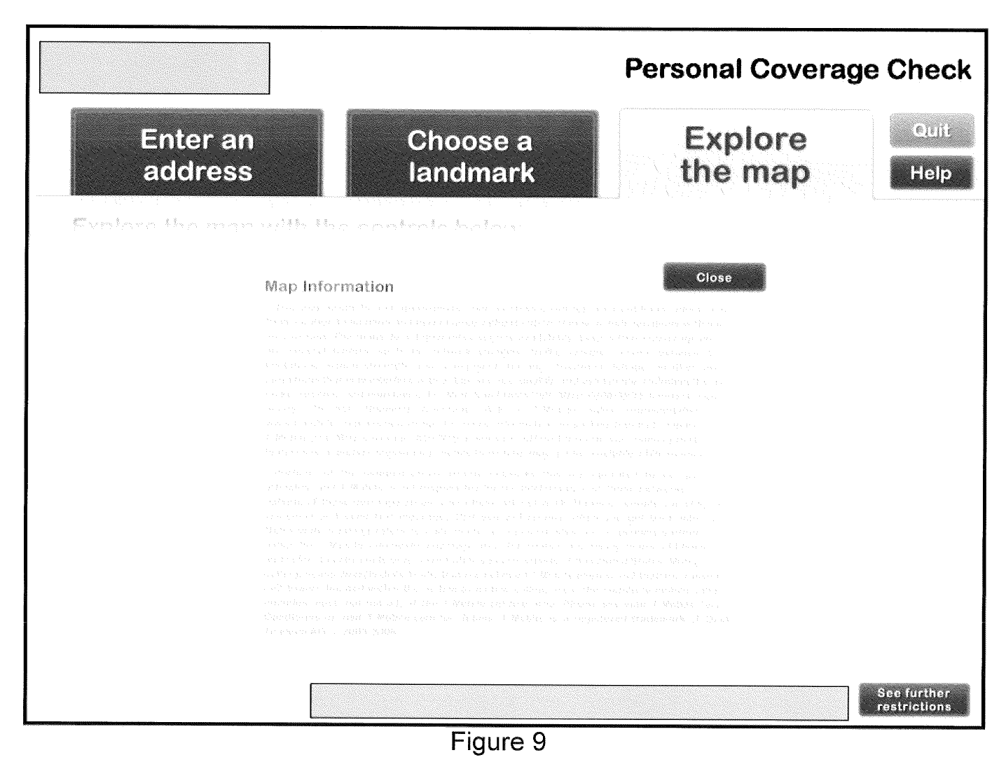

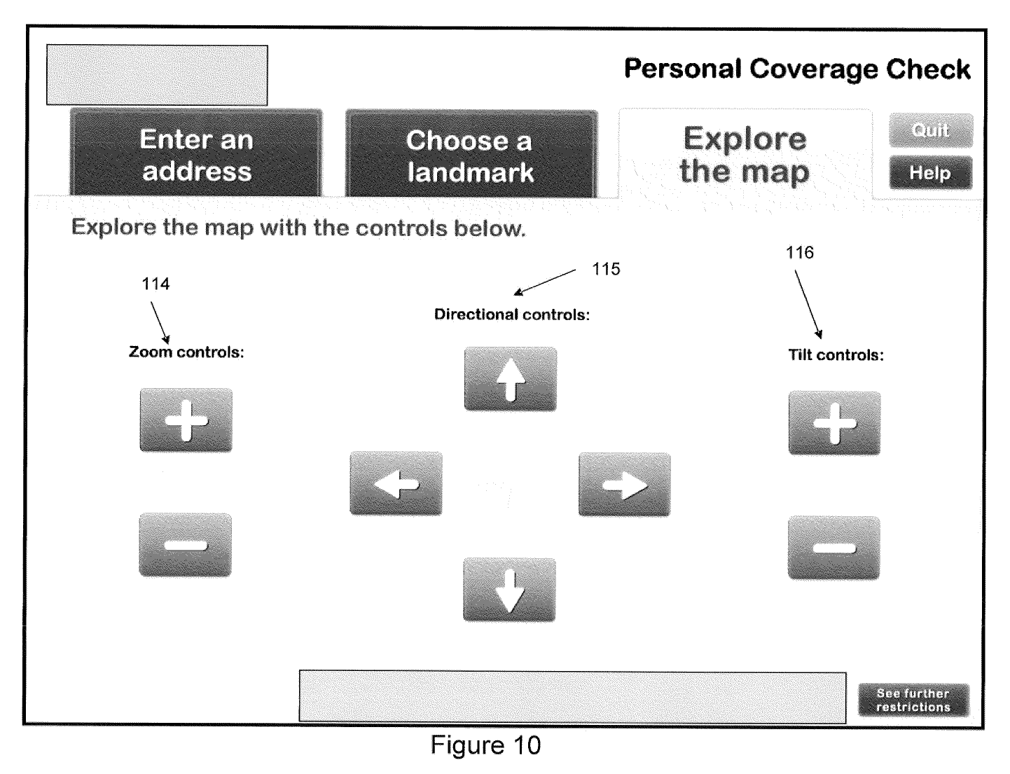

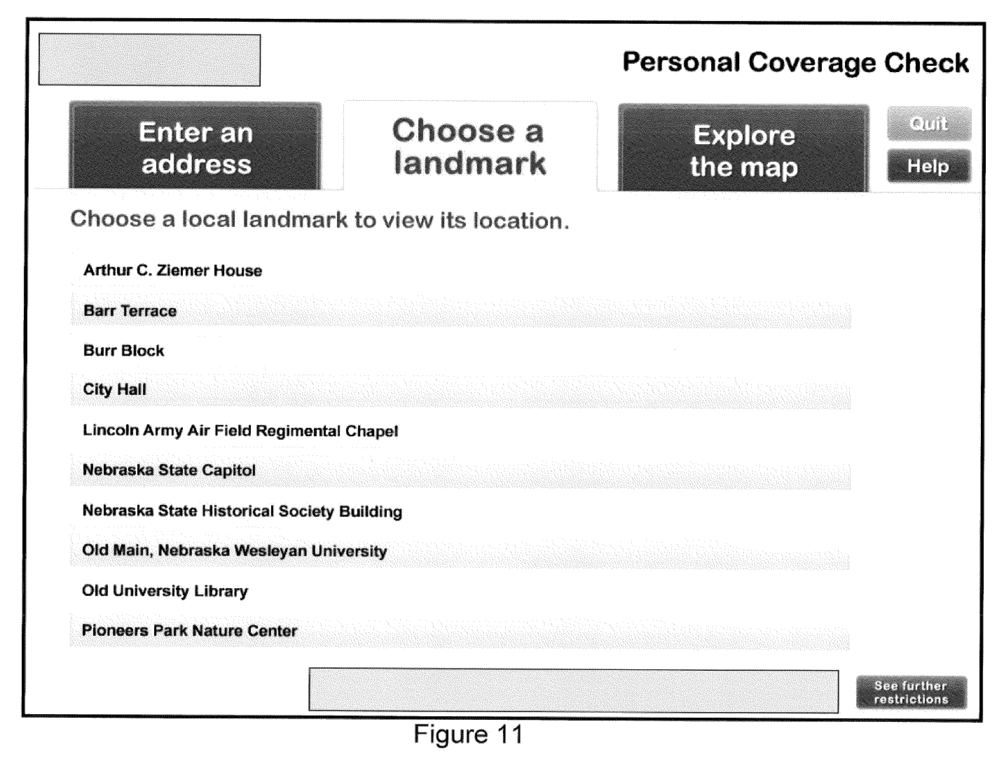

Once at the specified location, the user can “explore the map” (e.g., FIG. 9). Similar to 1220, the user is provided with map controls 1235, (e.g., as illustrated by FIG. 10). This feature allows the user to use zoom controls 114, directional controls 115, and/or tilt controls 116. Alternatively, as displayed in FIG. 11, instead of using the search box (e.g., 110), the user can activate a process to check the wireless service access by choosing a landmark (e.g., FIG. 11). This takes the user to the location of the landmark in a similar manner as if the user entered the address of the landmark in step 1225.

In an embodiment, after reaching a destination location, a video segment is launched automatically or upon manual selection. For example, based on the geographic location of the destination or the signal strength value at the destination location, the example method may launch an audio or video segment relevant to the coverage at the destination location. For example, if the signal strength at the destination location is weak, the application launches a video that educates the user about a wireless service provider product that can improve the coverage in that area. In an embodiment, the user is provided with icons that the user can select to launch video segments with content related to the wireless access coverage.

It will be appreciated that all of the disclosed methods and procedures described herein can be implemented using one or more computer programs or components. These components may be provided as a series of computer instructions on any conventional computer-readable medium, including RAM, ROM, flash memory, magnetic or optical disks, optical memory, or other storage media. The instructions may be configured to be executed by a processor which, when executing the series of computer instructions, performs or facilitates the performance of all or part of the disclosed methods and procedures.

It should be understood that there exist implementations of other variations and modifications of the invention and its various aspects, as may be readily apparent to those of ordinary skill in the art, and that the invention is not limited by specific embodiments described herein. Features and embodiments described above are combinable with and without each other. It is therefore contemplated that the present invention covers any and all modifications, variations, combinations or equivalents that fall within the scope of the basic underlying principals disclosed and claimed herein.

What is claimed is:

1. A system for providing signal strength data, comprising:
a display screen;
a computer processor, the computer processor providing information to the display screen;
a user interface, the user interface being generated at least in part from information provided by the computer processor and being displayable on the display screen;
wherein the information includes data concerning a wireless signal strength of a network provider in a specific geographic area, the user interface displaying the information in a multi-dimensional view in response to at least one of: a dynamic instruction and a preloaded instruction.

2. The system of claim 1, wherein the dynamic instruction is derived from a request inputted via the user interface.

3. The system of claim 1, wherein the preloaded instruction is a stored instruction on a memory of the computer processor or an accessible remote memory source.

4. The system of claim 1, wherein the computer processor obtains the information from at least one of: Internet, a remote information source, a server, and a computer-readable memory device.

5. The system of claim 1, wherein the display screen and the computer processor are a standalone system.

6. The system of claim 1, wherein the display of the specific geographic area is a three-dimensional view.

7. The system of claim 1, wherein the at least one of the dynamic instruction and the preloaded instruction is a display request for the specific geographic area based on at least one of the following parameters: geographic coordinates, relative signal strength, relative signal weakness, and a commercial location with a certain signal strength.

8. A method for displaying a wireless signal strength, comprising:
providing an instruction to a computer processor via a user interface on a display, the instruction including a request for information of the wireless signal strength for at least one parameter;
receiving the information by the computer processor; and
displaying the information via a multi-dimensional graphical geographical view by the computer processor on the display, the multi-dimensional view being at least two-dimensional or greater.

9. The method of claim 8, wherein the instruction is provided to the computer processor via the user interface by at least one of a manual input and an automatic input.

10. The method of claim 9, wherein the at least one of the manual input and the automatic input is from at least one of: a computer-readable memory source, a remote source, an Internet source, a server, a manual-input device, a soft-key input device on the user interface, and a wireless device via a transport protocol.

11. The method of claim 10, wherein the display is a display screen, the display screen being provided as a stand alone-accessible device having access to the computer processor.

12. The method of claim 8, wherein the at least one parameter is at least one of: a geographic coordinate, a geographic region, a relative signal strength, a landmark, a business entity, a relative signal weakness, and a residential location.

13. The method of claim 9, wherein the at least one of the manual input and the automatic input provides at least one of a dynamic instruction and a pre-loaded instruction.

14. A user interface of a communication device, comprising:
an input display allowing instructional input of a search parameter;
a multi-dimensional graphical geographical view generated by an associated computer processor being displayed via the user interface of the communication device,
wherein at least one wireless carrier signal strength is shown on the multi-dimensional graphical geographical view,
wherein the instructional input is effected via at least one of a soft-key function shown on the input display, a hard-key function via a keyboard device associated with the display, and a source remote to the input display.

15. The user interface of claim 14, wherein the search parameter is at least one of a geographic coordinate, an address, a landmark name, a relative signal strength, a business entity, a relative signal weakness, and a residential location.

16. The user interface of claim 14, wherein the input display provides input fields for a location address.

17. The user interface of claim 14, further comprising:
a location name display allowing input of the search parameter which includes a request to view a specific location, the location name display showing a list of locations, the list of locations being filterable to provide a subset of locations for selection, and in response to a selection of the specific location from the list of locations, the corresponding geographical view is displayed by the user interface.

18. The user interface of claim 14, further comprising:
a map display allowing input of the search parameter which includes a request to explore a map, the map display being navigated using controls, and in response to use of the navigation controls the corresponding geographical view is displayed by the user interface, wherein the navigation controls are effected via at least one of a soft-key function shown on the map display, a hard-key function via a keyboard device associated with the map display, and a source remote to the map display.

19. The user interface of claim 18, wherein the navigation controls include at least one of a directional control, a tilt control, a zoom-in control, and a zoom-out control.
